(19) United States
(12) Patent Application Publication
(10) Pub. No.: US 2019/0124416 A1
(43) Pub. Date: Apr. 25, 2019

(54) SERVER, OUTPUTTING METHOD, PROGRAM, AND DISPLAY SYSTEM

(71) Applicant: SHARP KABUSHIKI KAISHA, Sakai City, Osaka (JP)

(72) Inventors: MOTOKI SONE, Sakai City (JP); HISAYASU MOCHIZUKI, Sakai City (JP)

(21) Appl. No.: 16/093,085

(22) PCT Filed: Feb. 8, 2017
(86) PCT No.: PCT/JP2017/004478

§ 371 Date: Oct. 11, 2018

(30) Foreign Application Priority Data
Apr. 12, 2016 (JP) 2016-079869

(51) Int. Cl. H04N 21/8358

(52) U.S. Cl. CPC H04N 21/8358

(57) ABSTRACT

In order to display a copyright of content properly, a display information management server control section (14) of a display information management server (10) selects one or more cards (100) to be outputted to a display device (60), identifies a character string related to a copyright of content indicated by each of the one or more cards selected, extracts, from a copyright character string storage section (18), a character string associated with the character string identified, and outputs copyright information including the character string extracted to the display device.

### TECHNICAL FIELD

The present invention relates to a server, an outputting method, a program, and a display system.

### BACKGROUND ART

When providing content, it is necessary to display, together with the content, copyright information which is information on a copyright of the content. For this purpose, technologies of displaying copyright information of content have been disclosed. For example, Patent Literature 1 discloses a content processing device which displays a copyright management standard of each content in a content list such that the copyright management standard is associated with the each content.

### CITATION LIST

### Patent Literature

[Patent Literature 1]

Japanese Patent Application Publication, Tokukai, No. 2007-257766 A (Publication Date: Oct. 4, 2007)

### SUMMARY OF INVENTION

### Technical Problem

Meanwhile, various needs exist with respect to display of copyright information. These days, copyright information is often included in content itself, but in a case of conventional content, which does not contain any copyright information in itself, there is a demand that copyright information be displayed separately from the content.

Further, even in a case where copyright information is included in content itself, the copyright information may be changed, and thus there is a demand that the copyright information be displayed separately from the content. Further, as to timing of displaying copyright information, there are both a demand that the copyright information be displayed when the content is reproduced and a demand that the copyright information be displayed immediately before the content ends. Patent Literature 1 cannot meet these various demands.

In order to solve these problems, there are some content providers which each publish, on a website on the Internet, copyright information of all content which the provider holds. However, an amount of the copyright information of all content held by each content provider is so large that in a case where the copyright information is displayed on a display device having limited resolution (e.g., a television receiver, a smartphone, etc.), characters may be too small to be read. Further, in a case of a terminal having limited processing capability (e.g., a television receiver etc.), it may take too much time to display copyright information, or the copyright information may not be displayed properly due to a lack of a memory for performing display.

The present invention is accomplished in view of the foregoing problems. An object of the present invention is to provide a technology with which information related to a copyright of content is properly provided.

### Solution to Problem

In order to attain the object, a server in accordance with one aspect of the present invention is a server including: a control section; and a communication section, the control section being configured to: select one or more display objects to be outputted to a terminal; identify a character string related to a copyright of content indicated by each of the one or more display objects selected; extract, from a database, one or a plurality of character strings associated with the character string identified; and output, to the terminal, copyright information including the one or plurality of character strings extracted.

In order to attain the object, an outputting method in accordance with one aspect of the present invention is an outputting method including: a display object selection step of selecting one or more display objects to be outputted to a terminal; a character string identification step of identifying a character string related to a copyright of content indicated by each of the one or more display objects selected; a character string extraction step of extracting, from a database, one or a plurality of character strings associated with the character string identified; and a copyright information outputting step of outputting, to the terminal, copyright information including the one or plurality of character strings extracted.

In order to attain the object, a program in accordance with one aspect of the present invention is a program for causing a computer to function as a server including: a control section; and a communication section, the program being configured to cause the control section to perform the steps of: selecting one or more display objects to be outputted to a terminal; identifying a character string related to a copyright of content indicated by each of the one or more display objects selected; extracting, from a database, one or a plurality of character strings associated with the character string identified; and outputting, to the terminal via the communication section, copyright information including the one or plurality of character strings extracted.

In order to attain the object, a display system in accordance with one aspect of the present invention is a display system including: a display device; and a server, the server including a server control section and a server communication section, the server control section being configured to: receive, from the display device via the server communication section, a request for output of a display object; select one or more display objects to be outputted to the display device; output, to the display device via the server communication section, the one or more display objects selected; receive, from the display device via the server communication section, a request for output of copyright information; identify a character string related to a copyright of content indicated by each of the one or more display objects selected; extract, from a database, one or a plurality of character strings associated with the character string identified; and output, to the display device, copyright information including the one or plurality of character strings extracted, the display device including a display device control section, a display device communication section, and a display section, the display device control section being configured to: request, to the server via the display device communication section, output of a display object; obtain a display object from the server via the display device communication section; request the server for copyright information via the display device communication section; obtain the copyright information via the display device communication section; and cause the display section to display an image containing the copyright information.

### Advantageous Effects of Invention

According to one aspect of the present invention, information related to a copyright of content can be properly displayed.

### BRIEF DESCRIPTION OF DRAWINGS

FIG. 1 is a block diagram illustrating a configuration of a main part of a display system in accordance with Embodiment 1 of the present invention.

FIG. 2 is a view illustrating a configuration of a card in Embodiment 1 of the present invention.

FIG. 3 is a view illustrating an example of a configuration of meta data in accordance with Embodiment 1 of the present invention.

FIG. 4 is a flowchart showing processes performed by the display system in accordance with Embodiment 1 of the present invention.

FIG. 5 is a view illustrating an example of an image displayed by the display device in Embodiment 1 of the present invention.

FIG. 6 is a view illustrating an example of an image of a copyright displayed in accordance with Embodiment 1 of the present invention.

FIG. 7 is a flowchart illustrating processes performed by a display system in accordance with Embodiment 2 of the present invention.

FIG. 8 is a block diagram illustrating a hardware configuration of a computer by which a display information management server, a meta data management server, an STB, and a display device can be realized.

### DESCRIPTION OF EMBODIMENTS

### Embodiment 1

The following description will discuss in detail Embodiment 1 of the present invention.

(Display System 1)

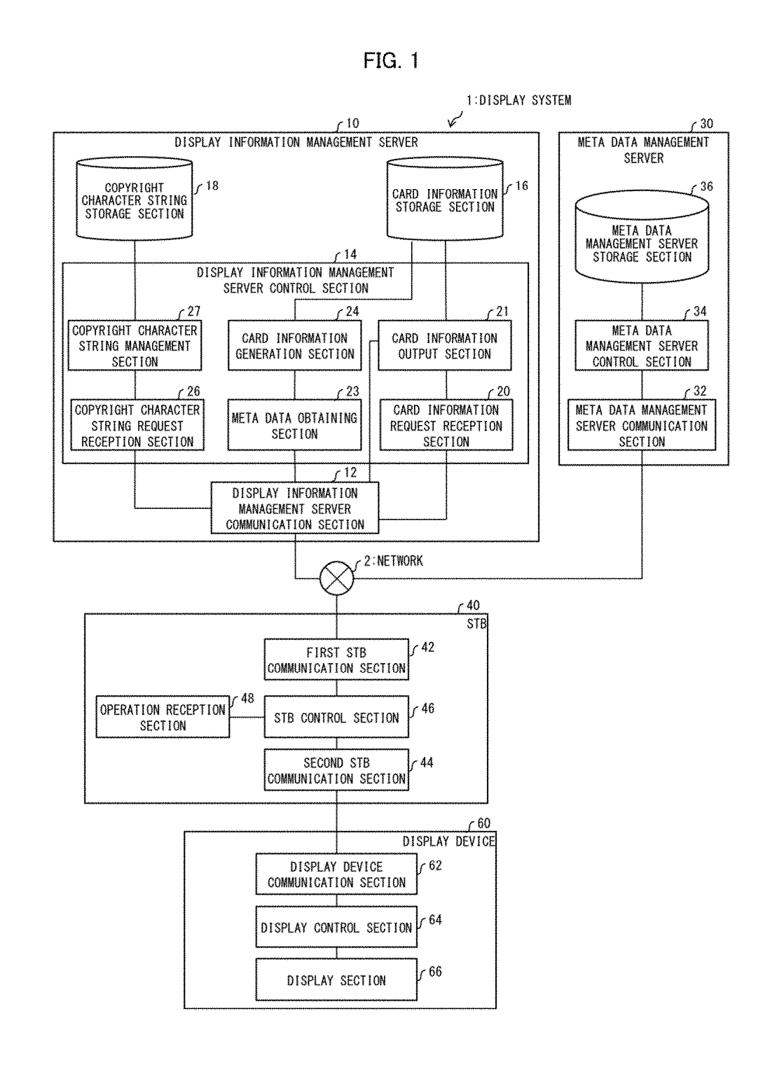

FIG. 1 is a block diagram illustrating a configuration of a main part of a display system 1 in accordance with Embodiment 1. As shown in FIG. 1, the display system 1 includes a display information management server (a server) 10, a meta data management server 30, a set-top box 40 (hereinafter referred to as “STB 40”), and a display device (terminal) 60. In the display system 1, the display information management server 10, the meta data management server 30, and the STB 40 are communicably connected to one another via a network 2. Further, the STB 40 and the display device 60 are communicably connected to each other. Note that the STB 40 may be included in the display device 60.

In the display system 1, the display information management server 10 outputs, to the STB 40, card information which indicates a card (an display object) for receiving content, and the display device 60 connected to the STB 40 displays the card. The user can select the card displayed on the display device 60 so as to view the content associated with the card thus selected. Herein, an example case is discussed in which the content is (i) a moving image delivered by the server and (ii) a broadcast program contained in a broadcast wave received by the STB 40 or the display device 60. However, the present invention is not limited to such an example case.

Further, in the display system 1, the display information management server 10 outputs, to the STB 40, information on a copyright of the content associated with the card indicated by the card information outputted to the STB 40. Examples of the information on the copyright of the content encompass a copyright character string, which is a character string indicative of a name of an owner of the copyright.

(Display Information Management Server 10)

As illustrated in FIG. 1, the display information management server 10 includes a display information management server communication section (a communication section, a server communication section) 12, a display information management server control section (a control section, a server control section) 14, a card information storage section 16, and a copyright character string storage section (a database) 18. The display information management server 10 is a server which manages the card information, which is stored in the card information storage section 16, and the copyright character string, which is stored in the copyright character string storage section 18.

The display information management server communication section 12 is a communication interface for performing communications with an external device via the network 2.

The display information management server control section 14 is an arithmetic logic unit having a function of performing overall control of sections of the display information management server 10. Details of the display information management server control section 14 will be described later.

The card information storage section 16 stores therein the card information which is information indicative of the card.

The copyright character string storage section 18 stores therein the copyright character string. The copyright character string stored in the copyright character string storage section 18 may be updated by an operator who manages the display information management server 10, or may be updated by an operator who delivers content.

(Display Information Management Server Control Section 14)

The display information management server control section 14 includes a card information request reception section 20, a card information output section 21, a meta data obtaining section 23, a card information generation section 24, a copyright character string request reception section 26, and a copyright character string management section 27. Processes performed by the display information management server control section 14 will be described with reference to another drawing.

The card information request reception section 20 receives a card information request, which is a request for output of the card information.

The card information output section 21 outputs the card information in accordance with the card information request.

The meta data obtaining section 23 obtains meta data, which is information on the content. The meta data contains a character string related to a copyright of the content, a period during which the content is provided, a provider of the content, a title of the content, etc.

The card information generation section 24 generates the card information with reference to the meta data.

The copyright character string request reception section 26 receives a copyright character string request, which is a request for output of the copyright character string.

The copyright character string management section 27 manages the copyright character string.

(Meta Data Management Server 30)

As illustrated in FIG. 1, the meta data management server 30 includes a meta data management server communication section 32, a meta data management server control section 34, and a meta data management server storage section 36. The meta data management server 30 has a function of managing the meta data.

The meta data management server communication section 32 is a communication interface for performing communications with an external device via the network 2.

The meta data management server control section 34 is an arithmetic logic unit having a function of performing overall control of sections of the meta data management server 30.

The meta data management server storage section 36 stores therein the meta data.

(STB 40)

As illustrated in FIG. 1, the STB 40 includes a first STB communication section 42, a second STB communication section 44, an STB control section 46, and an operation reception section 48. The STB 40 requests the display information management server 10 for the card information, and obtains the card information. Then, the STB 40 outputs, to the display device 60, an image containing the card indicated by the card information obtained, and causes the display device 60 to display the card.

The first STB communication section 42 is a communication interface for performing communications with an external device via the network 2.

The second STB communication section 44 is a communication interface for performing communications with an external device.

The STB control section 46 is an arithmetic logic unit having a function of performing overall control of sections of the STB 40.

The operation reception section 48 receives an operation from a user, and outputs an operation signal indicative of the operation received.

(Display Device 60)

As illustrated in FIG. 1, the display device 60 includes a display device communication section 62, a display control section (a display device control section) 64, and a display section 66. The display device 60 is a device which displays an image which has been obtained.

The display device communication section 62 is a communication interface for performing communications with an external device.

The display control section 64 is an arithmetic logic unit having a function of performing overall control of sections of the display device 60.

The display section 66 is a display device which is capable of displaying an image.

(Configuration of Card)

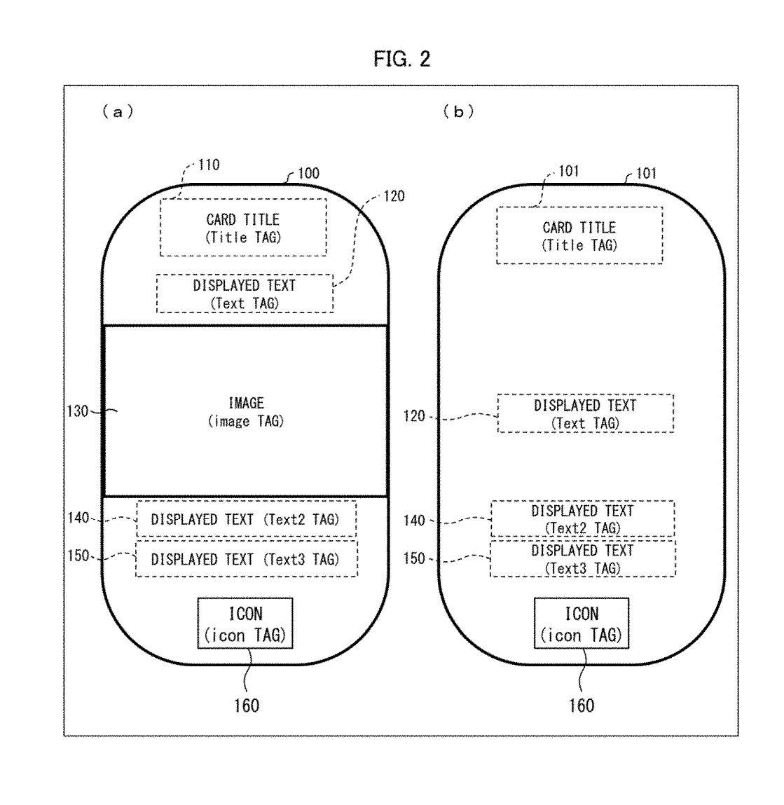

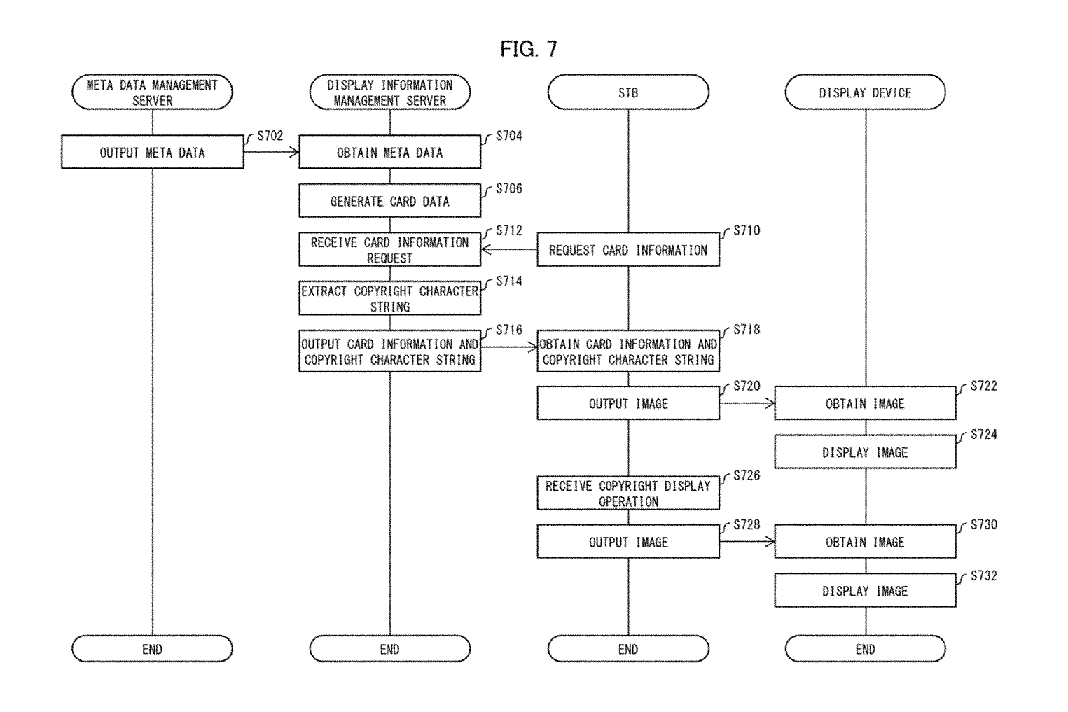

FIG. 2 is a view illustrating a configuration of the card in Embodiment 1 of the present invention. (a) of FIG. 2 is an example of the configuration of the card, and (b) of FIG. 2 is another example of the configuration of the card. The configuration of the card which the STB 40 causes the display device 60 to display will be described with reference to FIG. 7.

As illustrated in FIG. 2, the STB 40 causes the display device 60 to display a card on which information included in card information is added to each of tags associated with respective regions of the card. In the example of a card 100 illustrated in (a) of FIG. 2, a card title 110, a Text tag 120, an image tag 130, a Text2 tag 140, a Text3 tag 150, and an icon tag 160 are included in the card 100.

In the card title 110, a name of a title included in the card information is displayed. In the Text tag 120, the Text2 tag 140, and the Text3 tag 150, respective meta data included in the card information are displayed. For example, a reproducing time, a price, and a production company are displayed in the Text2 tag 120, the Text2 tag 140, and the Text3 tag 150, respectively. In the image tag 130, a thumbnail included in the card information is displayed. In the icon tag 160, an image of an icon included in the card information is displayed.

Thus, in the display system 1, a card displayed on the display device 60 contains meta data included in card information. Accordingly, in the display system 1, a card which includes various pieces of information of content can be presented, so that a user can select content desired by the user.

In a case where the card information includes no thumbnail, a card 101 illustrated in (b) of FIG. 7 may be displayed. As illustrated in (b) of FIG. 7, the card 101 includes the card title 110, the Text tag 120, the Text2 tag 140, the Text3 tag 150, and the icon tag 160.

Thus, in the display system 1, even in a case where a card to be displayed on the display device 60 contains no thumbnail image, the card which contains various pieces of information of content can be presented, so that a user can select content desired by the user.

(Example of Configuration of Meta Data)

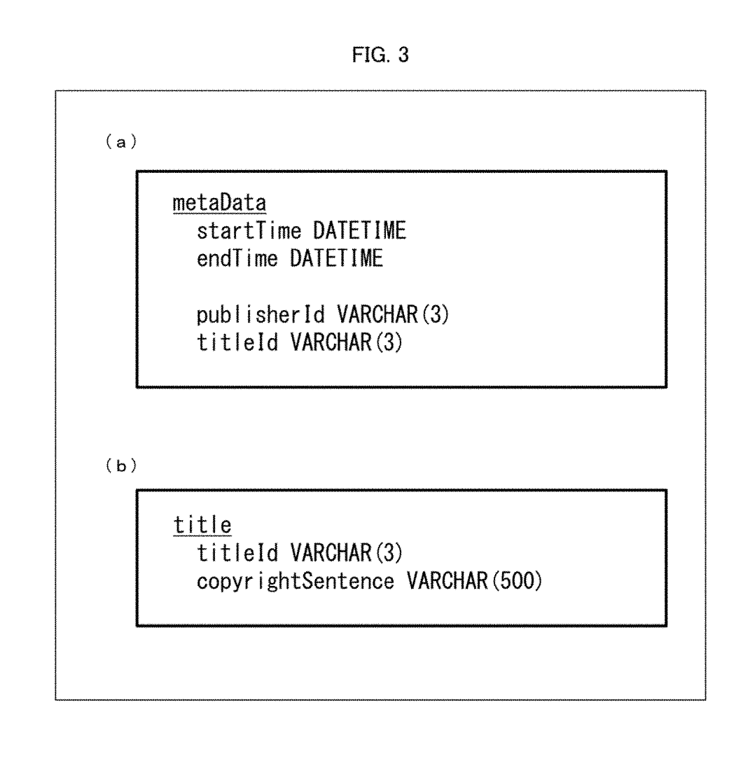

FIG. 3 is a view illustrating an example of a configuration of meta data of content in accordance with Embodiment 1. (a) of FIG. 3 is a view illustrating a data definition statement of meta data “metaData” (first meta data). As shown in (a) of FIG. 3, the meta data “metaData” includes startTime, endTime, publisherId, and titleId.

StartTime indicates a date and time at which provision of the content is started.

EndTime indicates a date and time at which the provision of the content is ended.

In other words, startTime and endTime indicate a period during which the content is provided, and are data which allow determining whether or not the content is being provided on a predetermined date and time.

PublisherId indicates identification information for identifying a provider of the content.

TitleId indicates identification information for identifying a title of the content.

(b) of FIG. 3 is a view illustrating a data definition statement of meta data “title” (second meta data). As shown in (b) of FIG. 3, the meta data “title” includes titleId and copyrightSentence.

TitleId indicates identification information for identifying a title of the content.

CopyrightSentence indicates a character string related to an owner of a copyright of the content. Unlike a copyright character string, which is a character string indicative of a name of the owner of the copyright, the character string related to the owner of the copyright can be, for example, a character string which includes part of the copyright character string. For example, in a case where the character string indicative of the name of the owner of the character string is “ABC2000”, examples of the character string related to the owner of the copyright encompass “ABC”, “2000”, “abc”, “ei bi shi” (phonological representation of “ABC” when written in katakana), “ni zero” (phonological representation of “20” when written in hiragana, wherein “ni” is a Japanese word meaning “2”), and the like.

(Processes Performed by Display System 1)

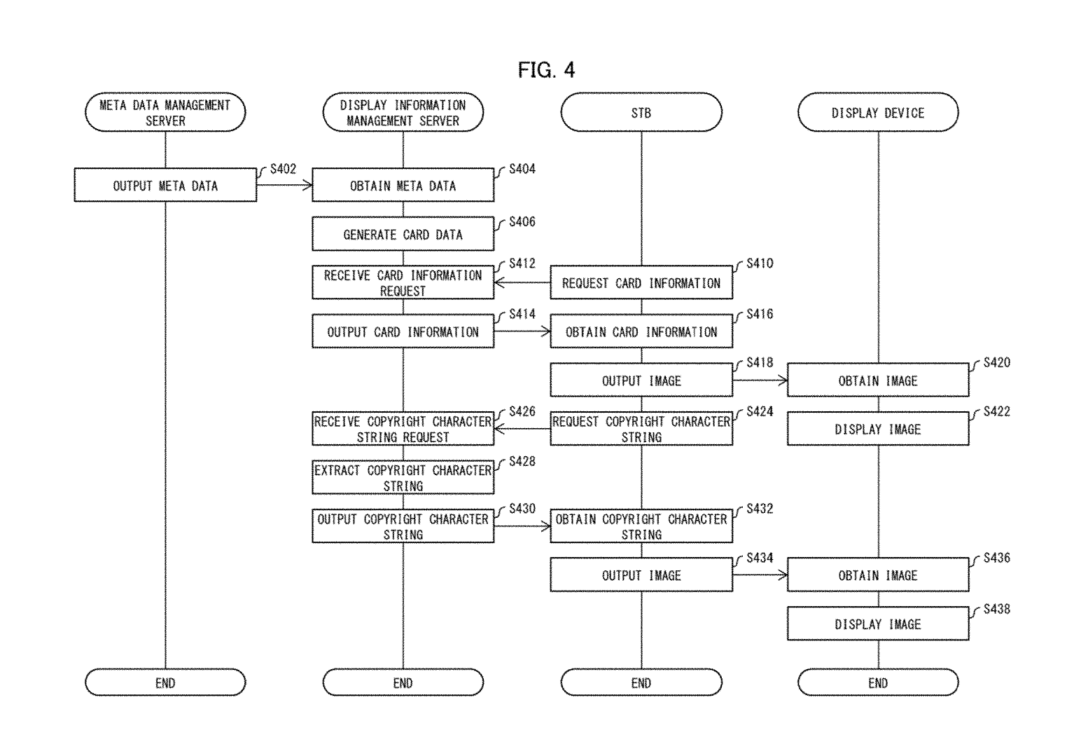

FIG. 4 is a flowchart showing processes performed by the display system 1 in accordance with Embodiment 1.

First, the meta data management server 30 outputs meta data to the display information management server 10 (S402). Specifically, the meta data management server control section 34 obtains the meta data from the meta data management server storage section 36, and transmits the meta data thus obtained to the display information management server 10 via the meta data management server communication section 32. Timing at which the meta data management server control section 34 obtains the meta data can be, for example, (i) when the meta data stored in the meta data management server storage section 36 has been updated, (ii) when a predetermined time has passed, and (iii) the like.

Subsequently, the meta data obtaining section 23 of the display information management server 10 obtains the meta data via the display information management server communication section 12 (S404). Then, the card information generation section 24 generates card information with reference to the meta data obtained by the meta data obtaining section 23 (S406).

In a case where the operation reception section 48 of the STB 40 receives an operation representing an instruction to display card information, the STB control section 46 requests the display information management server 10 for card information via the first STB communication section 42 (S410).

The card information request reception section 20 of the display information management server 10 receives the card information request from the STB 40 via the display information management server communication section 12 (S412). In a case where the card information request reception section 20 receives the card information request, the card information output section 21 selects card information indicative of one or more cards from the card information storage section 16, and outputs the card information thus selected to the STB 40 via the display information management server communication section 12 (S414: a display object selection step). Note that a method by which the card information output section 21 selects the card information is not particularly limited, but can be, for example, a method in which, in a case where the meta data illustrated in FIG. 3 is included in the card information, the card information output section 21 refers to startTime and endTime of the meta data “metaData” and selects card information corresponding to providable content.

The STB control section 46 of the STB 40 obtains the card information from the display information management server 10 via the first STB communication section 42 (S416). Then, the STB control section 46 outputs, to the display device 60 via the second STB communication section 44, an image containing the one or more cards indicated by the card information obtained (S418).

In the display device 60, the display control section 64 obtains, via the display device communication section 62, the image containing the one or more cards indicated by the card information (S420). Then, the display control section 64 causes the display section 66 to display the image obtained (S422).

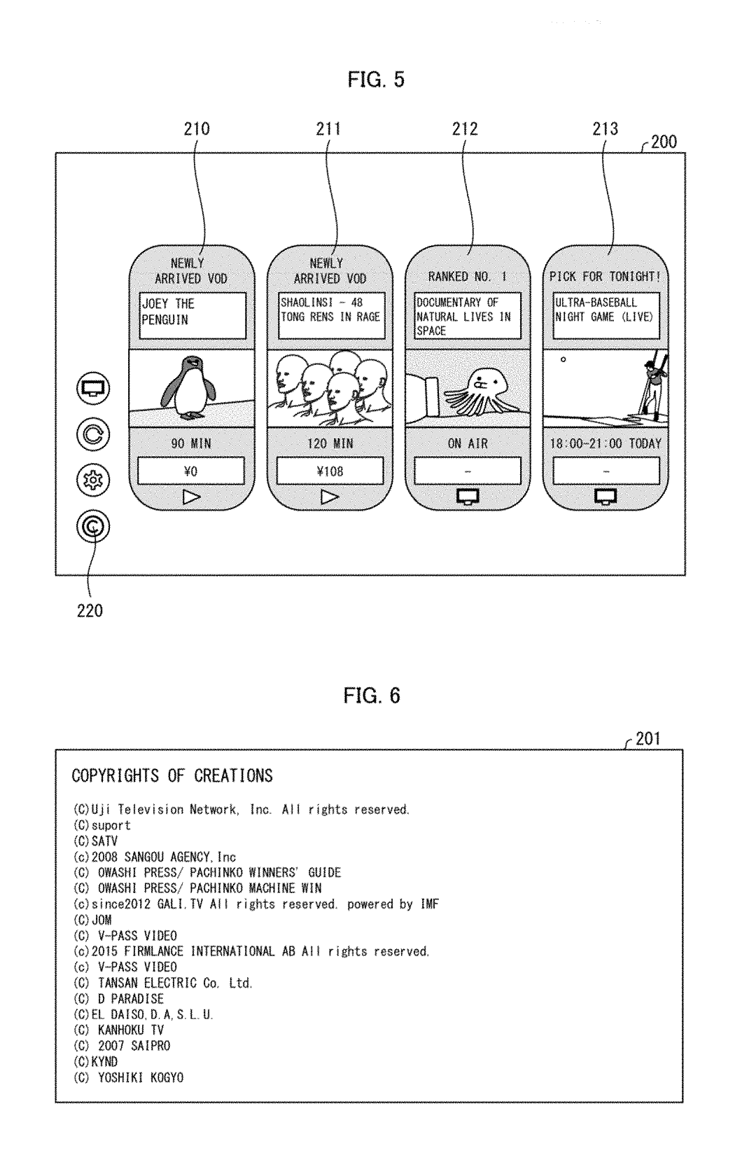

In a case where the operation reception section 48 of the STB 40 receives an operation representing an intention to display a copyright character string (for example, in a case where the operation reception section 48 receives an operation of clicking a copyright icon 220 illustrated in FIG. 5 (described later)), the STB control section 46 requests the display information management server 10 for a copyright character string via the first STB communication section 42 (S424).

The copyright character string request reception section 26 of the display information management server 10 receives the copyright character string request from the STB 40 via the display information management server communication section 12 (S426). In a case where the copyright character string request reception section 26 receives the copyright character string request, the copyright character string management section 27 identifies a character string that is related to a copyright of content corresponding to the card information which has been selected at step S414 by the card information output section (a character string identification step). Then, the copyright character string management section 27 extracts, from the copyright character string storage section 18, a copyright character string that is associated with the character string identified (S428: a character string extraction step).

For example, in a case where the card information includes the meta data illustrated in FIG. 3, the copyright character string management section 27 obtains titleId included in the meta data “metaData”, and extracts, from a group of meta data “title”, meta data “title” that includes titleId corresponding to thus obtained titleId.

Then, the copyright character string management section 27 obtains copyrightSentence included in the meta data “title” thus extracted, and searches the copyright character string storage section 18 for a copyright character string related to a character string of copyrightSentence thus obtained. In this case, the copyright character string management section 27 searches for character strings which include a notational variant (e.g., an uppercase English letter, a lowercase English letter, a katakana writing, whether or not an era name is included).

Note that in a case where extracted copyright character strings overlap with each other, the copyright character string management section 27 may retain one of the overlapping copyright character strings and delete the other(s) of the copyright character strings.

Subsequently, the copyright character string management section 27 outputs, to the STB 40 via the display information management server communication section 12, the copyright character string (copyright information) extracted (S430: a copyright information outputting step).

The STB control section 46 of the STB 40 obtains the copyright character string from the display information management server 10 via the first STB communication section 42 (S432). Then, the STB control section 46 outputs an image containing the copyright character string thus obtained to the display device 60 via the second STB communication section 44 (S434).

In the display device 60, the display control section 64 obtains the image containing the copyright character string via the display device communication section 62 (S436). Then, the display control section 64 causes the display section 66 to display the image thus obtained (S438).

Thus, in the display system 1 of Embodiment 1, the display information management server 10 outputs, to the STB 40, a copyright character string that is related to a copyright of content corresponding to card information obtained by the STB 40, among copyright character strings stored in the copyright character string storage section 18 of the display information management server 10. As such, the display information management server 10 does not output to the STB 40 a copyright character string of content that does not correspond to the card information obtained by the STB 40. This allows properly providing information related to a copyright of content.

(Example of Card)

FIG. 5 is a view illustrating an example of an image 200 displayed by the display device 60 in Embodiment 1 of the present invention. An example of a card which the STB 40 causes the display device 60 to display will be described with reference to FIG. 5.

As illustrated in FIG. 5, the STB 40 causes the display device 60 to display a card for each content. In the example illustrated in FIG. 5, a card 210, a card 211, a card 212, and a card 213 are displayed. The cards 210 through 213 each include a name of the content, a thumbnail image, a reproducing time, and a price.

In a case where the STB 40 receives an operation representing an intention to select a card contained in the image 200, the STB 40 connects to a connection destination which is indicated by a URL included in the card information indicating the card. Then, the STB 40 obtains content from the connection destination, and causes the display device 60 to display the content. Note that the STB 40 may be configured to instruct the display device 60 to connect to the URL.

Thus, in the display system 1, a card displayed by the display device 60 includes information such as a name of content, a thumbnail image, a reproducing time, and a price, which are information related to the content. Accordingly, with the display system 1, it is possible to cause a user to select content desired by the user.

Further, the image 200 contains the copyright icon 220 as illustrated in FIG. 5. The copyright icon 220 is an icon for displaying copyrights of (i) contents related to displayed cards and (ii) all contents that are not being displayed but are candidates for recommendation.

(Image Containing Copyright Character String)

FIG. 6 is a view illustrating an example of an image containing a copyright character string in accordance with Embodiment 1. As illustrated in FIG. 6, a list of copyright character strings associated with content corresponding to the card information outputted at S418 are displayed.

### Embodiment 2

The following description will discuss Embodiment 2 of the present invention. In Embodiment 2, a configuration will be described in which the STB 40 obtains card information and a copyright character string from the display information management server 10, and upon reception of an operation representing an intention to display a copyright character string, the STB 40 outputs the copyright character string to the display device 60 without requesting the display information management server 10 for the copyright character string.

FIG. 7 is a flowchart showing processes performed by a display system 1 in accordance with Embodiment 2. Note that a matter which has been already discussed in the descriptions of processes performed by the display system 1 in accordance with Embodiment 1 will be discussed only briefly or will not be discussed.

First, the meta data management server 30 outputs meta data to the display information management server 10 (S702). Specifically, the meta data management server control section 34 obtains the meta data from the meta data management server storage section 36, and transmits the meta data thus obtained to the display information management server 10 via the meta data management server communication section 32. Timing at which the meta data management server control section 34 obtains the meta data can be, for example, (i) when the meta data stored in the meta data management server storage section 36 has been updated, (ii) when a predetermined time has passed, and (iii) the like.

Subsequently, the meta data obtaining section 23 of the display information management server 10 obtains the meta data via the display information management server communication section 12 (S704). Then, the card information generation section 24 generates card information with reference to the meta data obtained by the meta data obtaining section 23 (S706).

In a case where the operation reception section 48 of the STB 40 receives an operation representing an instruction to display card information, the STB control section 46 requests the display information management server 10 for card information via the first STB communication section 42 (S710).

The card information request reception section 20 of the display information management server 10 receives a card information request from the STB 40 via the display information management server communication section 12 (S712). In a case where the card information request reception section 20 receives the card information request, the card information output section 21 selects, from the card information storage section 16, card information indicative of one or more cards. Further, the copyright character string management section 27 identifies a character string that is related to a copyright of content corresponding to the card information which has been selected by the card information output section 21. Then, the copyright character string management section 27 extracts, from the copyright character string storage section 18, a copyright character string that is associated with the character string identified (S714).

The card information output section 21 outputs, to the STB 40 via the display information management server communication section 12, the card information selected and the copyright character string (copyright information) extracted (S716).

The STB control section 46 of the STB 40 obtains the card information and the copyright character string from the display information management server 10 via the first STB communication section 42 (S718). Then, the STB control section 46 outputs an image containing the one or more cards indicated by the card information thus obtained to the display device 60 via the second STB communication section 44 (S720).

In the display device 60, the display control section 64 obtains, via the display device communication section 62, the image containing the one or more cards indicated by the card information (S722). Then, the display control section 64 causes the display section 66 to display the image obtained (S724).

The operation reception section 48 of the STB 40 receives an operation intending display of the copyright character string (S726). The STB control section 46 outputs, to the display device 60 via the second STB communication section 44, an image containing the copyright character string which has been obtained at S718 (S728).

In the display device 60, the display control section 64 obtains, via the display device communication section 62, the image containing the copyright character string (S730). Then, the display control section 64 causes the display section 66 to display the image thus obtained (S732).

Thus, in the display system 1 in Embodiment 2, the display information management server 10 outputs to the STB 40 a copyright character string together with card information. Accordingly, in a case where the STB 40 receives an operation representing an intention to display the copyright character string, the STB 40 does not communicate with the display information management server 10. This enables a reduction in number of communications performed between the display information management server 10 and the STB 40.

### Embodiment 3

Control blocks of each of the display information management server 10, the meta data management server 30, the STB 40, and the display device 60 (particularly, the display information management server control section 14, the meta data management server control section 34, the STB control section 46, and the display control section 64) may be realized by a logic circuit (hardware) provided in an integrated circuit (IC chip) or the like or may be realized by software as executed by a CPU (Central Processing Unit).

In the latter case, each of the display information management server 10, the meta data management server 30, the STB 40, and the display device 60 includes: a CPU that executes instructions of a program that is software realizing the foregoing functions; ROM (Read Only Memory) or a storage device (each referred to as “storage medium”) storing the program and various kinds of data in such a form that they are readable by a computer (or a CPU); and RAM (Random Access Memory) that develops the program in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be made available to the computer via any transmission medium (such as a communication network and a broadcast wave) which enables transmission of the program. Note that the present invention can also be implemented by the program in the form of a computer data signal embedded in a carrier wave which is embodied by electronic transmission.

### Embodiment 4

The preceding embodiments discussed examples in each of which a plurality of servers (the display information management server 10 and the meta data management server 30) are used. Alternatively, functions of the plurality of servers can be achieved by use of a single server or by use of a greater number of servers. In a case where a plurality of servers are employed, each server can be managed by the same operator or by differing operators.

### Embodiment 5

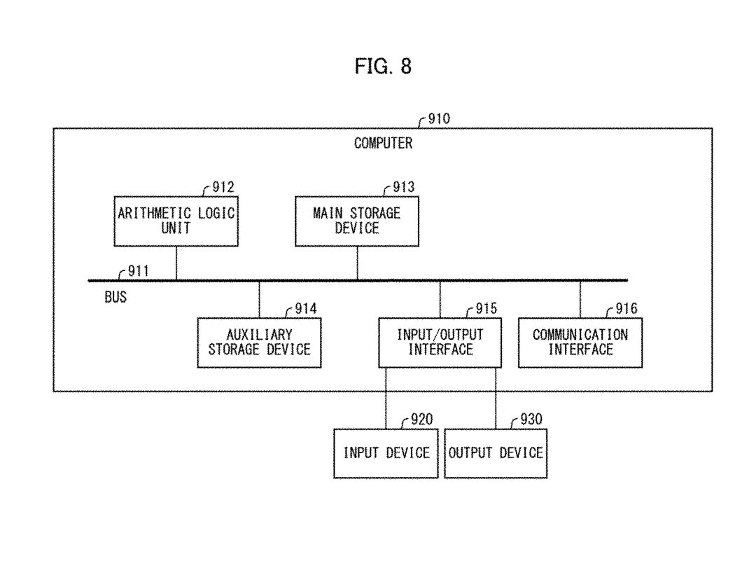

Each block of the display information management server 10, the meta data management server 30, the STB 40, and the display device 60 can be realized by a logic circuit (hardware) provided in an integrated circuit (IC chip) or the like or can be alternatively realized by software as executed by a central processing unit (CPU). In the latter case, the display information management server 10, the meta data management server 30, the STB 40, and the display device 60 can each be realized by a computer (electronic computer) as illustrated in FIG. 8.

FIG. 8 is a block diagram illustrating a hardware configuration of a computer 910 by which the display information management server 10, the meta data management server 30, the STB 40, and the display device 60 can be realized. The computer 910 includes (i) an arithmetic logic unit 912, (ii) a main storage device 913, (iii) an auxiliary storage device 914, (iv) an input/output interface 915, and (v) a communication interface 916 that are connected to each other via a bus 911. Each of the arithmetic logic unit 912, the main storage device 913, and the auxiliary storage device 914 can be realized by, for example, a CPU, a random access memory (RAM), or a hard disk drive. The input/output interface 915 is connected with (i) an input device 920 via which a user inputs various information into the computer 910 and (ii) an output device 930 via which the computer 910 outputs various information to the user. Each of the input device 920 and the output device 930 can be embedded in the computer 910 or can be alternatively connected to the computer 910 (externally connected to the computer 910). For example, the input device 920 can be a keyboard, a mouse, a touch sensor, or the like, and the output device 930 can be a display, a printer, a speaker, or the like. Alternatively, a device having both of a function of the input device 920 and a function of the output device 930 (such as a touch panel into which a touch sensor and a display are integrated) can be employed. The communication interface 916 is an interface via which the computer 910 communicates with an external device.

The auxiliary storage device 914 stores various programs for controlling the computer 910 to operate as the display information management server 10, the meta data management server 30, the STB 40, and the display device 60. The arithmetic logic unit 912 controls the computer 910 to operate as sections included in the display information management server 10, the meta data management server 30, the STB 40, and the display device 60 by (i) loading, onto the main storage device 913, the programs stored in the auxiliary storage device 914 and (ii) executing instructions carried out in the programs. Note that a recording medium which is included in the auxiliary storage device 914 for recording information, such as the various programs, only needs to be a computer-readable “non-transitory tangible medium.” Examples of the recording medium include tapes, disks, cards, semiconductor memories, and programmable logic circuits.

The various programs can be obtained from outside of the computer 910. In such a case, the various programs can be obtained via any transmission medium (such as a communication network or a broadcast wave). The present invention can also be achieved in the form of a computer data signal in which the various programs are embodied via electronic transmission and which is embedded in a carrier wave.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 display system
10 display information management server (server)
12 display information management server communication section (communication section, server communication section)
14 display information management server control section (control section, server control section)
18 copyright character string storage section (database)
60 display device (terminal)
62 display device communication section
64 display control section (display device control section)
66 display section
100 card (display object)

1. A server comprising:
a control section; and
a communication section,
the control section being configured to:
select one or more display objects to be outputted to a terminal;
identify a character string related to a copyright character string of content indicated by each of the one or more display objects selected;
extract, from a database, one or a plurality of character strings associated with the character string identified; and
output, to the terminal, copyright information indicative of the one or plurality of character strings extracted.

2. The server as set forth in claim 1, wherein the control section outputs the display object together with the copyright information to the terminal.

3. The server as set forth in claim 1, wherein the control section (i) identifies providable content and (ii) identifies a character string related to a copyright character string of the providable content identified.

4. The server as set forth in claim 1, wherein the control section extracts, from the database, one or a plurality of character strings including a notational variant of the character string identified.

5. An outputting method comprising:
a display object selection step of selecting one or more display objects to be outputted to a terminal;
a character string identification step of identifying a character string related to a copyright character string of content indicated by each of the one or more display objects selected;
a character string extraction step of extracting, from a database, one or a plurality of character strings associated with the character string identified; and
a copyright information outputting step of outputting, to the terminal, copyright information indicative of the one or plurality of character strings extracted.

6. (canceled)

7. A display system comprising:
a display device; and
a server,
the server including a server control section and a server communication section,
the server control section being configured to:
receive, from the display device via the server communication section, a request for output of a display object;
select one or more display objects to be outputted to the display device;
output, to the display device via the server communication section, the one or more display objects selected;
receive, from the display device via the server communication section, a request for output of copyright information;
identify a character string related to a copyright character string of content indicated by each of the one or more display objects selected;
extract, from a database, one or a plurality of character strings associated with the character string identified; and
output, to the display device, copyright information indicative of the one or plurality of character strings extracted,
the display device including a display device control section, a display device communication section, and a display section,
the display device control section being configured to:
request, to the server via the display device communication section, output of a display object;
obtain a display object from the server via the display device communication section;
request the server for copyright information via the display device communication section;
obtain the copyright information via the display device communication section; and
cause the display section to display an image containing the copyright information.

8. The server as set forth in claim 1, wherein in a case where there are overlapping character strings among the plurality of character strings extracted, the control section retains one of the overlapping character strings and deletes the other(s) of the overlapping character strings.
